(19) United States
(12) Patent Application Publication
(10) Pub. No.: US 2009/0197003 A1
(43) Pub. Date: Aug. 6, 2009

(54) Anti-fouling coatings, Compounds, and methods

(75) Inventor: Jerry Shira, Toronto (CA)

Correspondence Address: Thomas Van Zandt, P.O. BOX 41422, San Jose, CA, 95160, US

(73) Assignee: Thomas Van Zandt, San Jose, CA (US)

(21) Appl. No.: 12/322,196

(22) Filed: Jan. 29, 2009

Related U.S. Application Data
(60) Provisional application No. 61/063,266, filed on Feb. 1, 2008.

(51) Int. Cl. B05D 3/00; C09D 5/16

(52) U.S. Cl. 427/386; 424/78.09

(57) ABSTRACT

Methods and formulations for anti-fouling compounds are disclosed. Embodiments of the invention provide antifouling coatings compounds and methods that have significantly reduced ecological impact compared with prior art formulations. For one embodiment of the invention a coating does not contain copper or other compounds highly toxic to marine life. For one embodiment of the invention, components are used that are irritants to the organisms that typically attach themselves to marine surfaces. For one embodiment of the invention an anti-fouling coating includes an adhesion-reduction component that substantially reduces the ability of an organism to adhere to a coated surface.

### CROSS-REFERENCE TO RELATED APPLICATION

This application is related to and claims priority to provisional application Ser. No. 61/063,266, filed on Feb. 1, 2008, entitled “Anti-Fouling Coatings, Compounds, and Methods,” the teachings of which are incorporated by reference herein.

### FIELD

Embodiments of the invention relate generally to the field of coatings and include coatings having antifouling properties, anticorrosion properties and coatings for marine applications and non-marine applications.

### BACKGROUND

The problem of marine fouling and corrosion of ship hulls and marine installations is well known and has been addressed in many ways. One of the major problems with conventional coatings is that they typically contain components that are toxic to marine life and humans. This is particularly problematic where there significant interaction between human development and sensitive wildlife areas. For example, areas such as the Gulf of Mexico have a great deal of shipping and offshore oil wells as well as other construction including on-shore buildings that benefit from antifouling coatings. And yet these areas may be some of the most sensitive ecologically. Conventional solutions have used coatings having one or more toxic components to deter various living organisms from attaching and degrading the coated structure (e.g., ships, offshore structures, onshore structures exposed to the water).

The coating can also pose a danger to those who work with them in applying and removing them. Coatings formally relied on tin as a component, but tin has largely been replaced with copper or zinc as less harmful to humans when applying the coating. The copper provides several benefits including improving adhesion to the surface to be coated as well as a component of the base to facilitate adequate mixing of the various components. However, copper and zinc have long been recognized as significantly harmful to marine life and to the ecology in general.

Conventional antifouling compounds continue to use toxic components to deter living organisms and additional toxic components (e.g., copper or zinc) generally. As these materials (coatings, paints, etc.) find ever increasing utility and application in the marine industry, in naval operations, and other uses, their long-term detrimental impact on the environment near harbors, shipyards, wetlands, and generally will become more evident and more pronounced.

One well-known problematic marine organism is the barnacle. A barnacle is a type of arthropod belonging to the infraclass Cirripedia in the subphylum Crustacea.

The barnacle has two larval stages. The first larval stage, which lasts about two weeks, is called nauplius. In this stage the barnacle spends its time as part of the plankton while eating and molting. After two weeks the barnacle metamorphoses into the barnacle cyprid larva. Barnacles often attach themselves to man-made structures, sometimes to the structure's detriment, hence they are classified as fouling organisms. When an appropriate place is found, the cyprid larva cements itself headfirst to the surface (e.g., ships, wharves, pilings, bridges, offshore structures, etc) and then undergoes metamorphosis into a juvenile barnacle. Typical barnacles develop six hard armour plates to surround and protect their bodies. Once metamorphosis is over and they have reached their adult form, barnacles will continue to grow, but not molt, rather, they grow by adding new material to the ends of their heavily calcified plates.

Conventional methods of addressing the problem of barnacles include adding toxins to the marine coating to deter the barnacles from attaching to a surface and scraping the attached barnacles off the surface. As discussed above, the toxins in the marine coating adversely affect the people applying the coating as well as the marine environment as they eventually leach from the coated surface. Scraping barnacles adversely affects the coated surface and typically requires a recoating that adds to the toxins in the marine environment.

### BRIEF DESCRIPTION OF THE DRAWINGS

The invention may be best understood by referring to the following description and the accompanying drawings that are used to illustrate embodiments of the invention. In the drawings:

FIG. 1 illustrates a method for producing an antifouling coating including a non-toxic organism irritant in accordance with one embodiment of the invention; and

FIG. 2 illustrates a method for producing an antifouling coating including an adhesion-reduction component in accordance with one embodiment of the invention.

### DETAILED DESCRIPTION

Embodiments of the invention provide antifouling coatings compounds and methods that have significantly reduced ecological impact compared with prior art formulations. For one embodiment of the invention a coating does not contain copper or other compounds highly toxic to marine life. For one embodiment of the invention, components are used that are irritants to the organisms that typically attach themselves to marine surfaces. The irritants, while not toxic, adequately deter the organisms from attaching to the surface. For one such embodiment, non-toxic irritants can replace toxic components in typical antifouling compounds resulting in a greatly reduced ecological impact. Therefore, anti-fouling compounds can be made significantly less ecologically harmful by replacing organism-toxic components with organism-irritant components. Additionally, or alternatively, anti-fouling compounds can be made significantly less ecologically harmful by replacing the typically harmful coating-adhesion components (e.g., copper, zinc, tin, etc.) with one or more non-toxic (or significantly less toxic) components that provide substantially similar properties and results.

In accordance with one embodiment of the invention an epoxy resin in combination with other components forms an anti-fouling compound. For one such embodiment, one or more of the components (including the epoxy resin) is a skin irritant and therefore provides an anti-fouling functionality to the compound.

In alternative embodiments organisms are deterred from adhering to a coated surface by including an adhesion-reduction component in the coating compound. Such adhesion-reduction components substantially reduce the ability of organisms to adhere to the coated surface. For one such embodiment the coating is produced in multiple stages. The coating is produced and applied so that it adheres to a desired surface, but substantially reduces the ability of an organism to adhere to the applied coating. For one embodiment a primer coat that does not contain an adhesion-reduction component is applied to a surface and allowed to partially cure. A subsequent coating, containing an adhesion-reduction component is then applied. The two coating and optionally intermediate or subsequent coatings blend during a curing process. The resulting coating adheres adequately to the surface while substantially reducing the ability of organisms to adhere to the coating (e.g., to the coated surface).

Reference throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, components, structures, or characteristics may be combined in any suitable manner in one or more embodiments.

Moreover, inventive aspects lie in less than all features of a single disclosed embodiment. Thus, any claims following the Detailed Description are hereby expressly incorporated into this Detailed Description, with each claim standing on its own as a separate embodiment of this invention.

Embodiments of the invention are applicable in a variety of settings in which antifouling compounds, coatings, paints, or sealants are used. Such applications include, but are not limited to ships, onshore and offshore, structures, recreational marine vehicles and other objects subject similar fouling.

A method in accordance with one embodiment of the invention includes identifying non-toxic components that serve the same function as toxic components in typical prior art antifouling coatings. The toxic components are then replaced with the identified non-toxic components. An alternative method in accordance with one embodiment includes adding one or more adhesion-reduction components to the anti-fouling coating that substantially reduce the ability of an organism to adhere to the coated surface. The resulting antifouling coatings are significantly less detrimental to the ecology while producing substantially similar or improved antifouling characteristics. Specific example formulations for such coatings and compounds in accordance with alternative embodiments are included as Appendixes A and B.

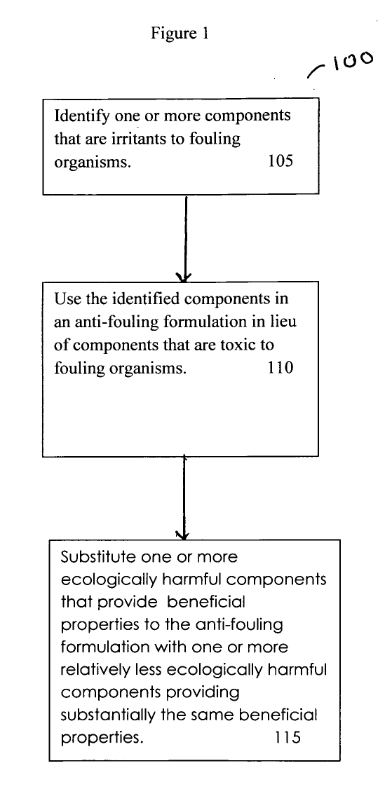

FIG. 1 illustrates a method for producing an antifouling coating that is significantly less detrimental to the environment in accordance with one embodiment of the invention.

Process 100, shown in FIG. 1 begins at operation 105 in which one or more components are identified that are irritants to fouling organisms (organism-irritants). These components are generally non-toxic to the organisms and to marine life in general in the amounts used.

At operation 110, the identified organism-irritant components are used in lieu of organism-toxic components of a conventional antifouling coating formulation.

As discussed above, embodiments of the invention may also replace generally, environmentally harmful components of antifouling coating formulations as well. Therefore for various alternative embodiments of the invention, one or more of copper, zinc, tin or other typical components of conventional antifouling coating formulations which are generally toxic and harmful to the environment are replaced with one or more less toxic components that provide substantially the same beneficial properties and results as the ecologically more harmful components.

For example, in accordance with one embodiment, copper, which is typically used in anti-fouling compounds to provide adhesion, mechanical strength, and facilitate application, as well as an organism irritant, is replaced by a compound that is significantly less harmful to the environment. For one embodiment of the invention, EPON 828 is used and copper or similar metals are eliminated from the anti-fouling formulation. EPON 828 provides the anti-fouling compound adhesion, mechanical strength, as well as dielectric and chemical resisting properties.

The following is a list of examples of some components that may be used in conjunction one with another to produce an improved anti-fouling compound. Also described is some of the ways in which these components function within an anti-fouling compound.

As mentioned above, for one embodiment of the invention, EPON 828, which is a hexion two-part bisphenol-A-(epichlorhydrin) product is used to provide anti-fouling, compound adhesion, mechanical strength, as well as dielectric and chemical resisting properties.

In accordance with one embodiment of the invention, a di-functional glycidyl ether (e.g., Cardolite NC 514) is used an epoxy resin which allows flexibility and can be used to reduce brittleness. It also has organism-irritant properties.

In accordance with one embodiment of the invention, a glycidyl ether (e.g., Lite 2513 HP) of cashew nutshell liquid combined with epichlorohydrin is used to form a modifier that improves flow and leveling and can significantly reduce pinholes, “fish eyes”, craters, and orange peeling. It can also improve adhesion by increasing substrate wetting. It has the added benefit of improving pigment dispersion. It also has organism-irritant properties.

In accordance with one embodiment of the invention, alumina-silica (Bentone 38) may be used.

In accordance with one embodiment of the invention, alumina-silica ceramic fibers are used as a functional additive to provide wear resistance, reinforcement, compressive strength, and corrosion resistance. For one embodiment, the alumina-silica ceramic fibers may be ball-milled (e.g., 734-000000)

In accordance with one embodiment of the invention, an ethyl acrylate (e.g., Modaflow) is used as a modifier to improve flow and leveling. It can significantly reduce pinholes, “fish eyes”, craters, and orange peeling. It can also improve adhesion by increasing substrate wetting. It has the added benefit of improving pigment dispersion. It is contained in a resin and is only slightly soluble in water. It also has organism-irritant properties.

In accordance with one embodiment of the invention, an alumina-silica clay is used to thicken the anti-fouling compound and reduce the settling of other components.

In accordance with one embodiment of the invention, barium metaborate (e.g., Busan 11-M1), which is a modified barium metaborate monohydrate is used for protection against mold, corrosion, tannin staining, microorganisms, and UV radiation. It is known to improve long-term performance and durability of paints and coatings. It also has organism-irritant properties.

In accordance with one embodiment of the invention, silica (SIL-CO-SIL #53), which is a crystalline silica is used as a suspending agent, and to provide abrasion and mar resistance. It also aids flattening, improves tear strength, adhesion, and tensile strength. It also improves heat-resistance without appreciably reducing flexibility.

In accordance with one embodiment of the invention, alkylated phenolic polymide (Lite 2002), which is a phenalkamine epoxy curing agent is used to enhance adhesion. It can significantly improve adhesion over prior art formulations in cold damp conditions over poorly prepared surfaces. It is insoluble in water, moisture tolerant during cure cycle and increases corrosion resistance. It also has organism-irritant properties.

For alternative embodiments, various types of pigments may be added to the formulation depending on application and preferences.

For other embodiments, the need for an organism irritant is obviated by the inclusion of an adhesion-reduction component.

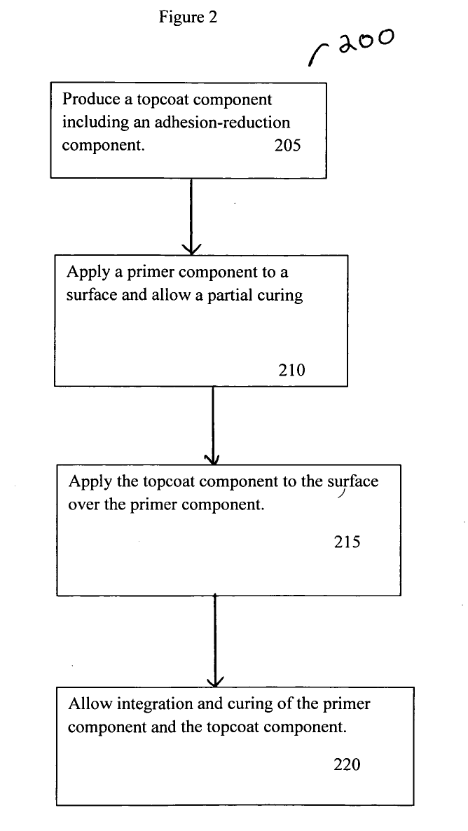

FIG. 2 illustrates a method for producing and applying an antifouling coating including an adhesion-reduction component in accordance with one embodiment of the invention.

Process 200, shown in FIG. 2 begins at operation 205 in which an anti-fouling coating including an adhesion-reduction component is produced. The adhesion-reduction component can include one or more of a number of substances that effect adhesion reduction. For example, for one embodiment, the adhesion reduction component includes one or more sterols produced from plants or animals. For one such embodiment, cholesterol-based compounds may be used as an adhesion-reduction component. One such commercially available adhesion-reduction component is degras. In general, substances containing plant or animal fat may be used as an adhesion-reduction compound as may other substances exhibiting adhesion-reduction properties. The adhesion-reduction components are generally non-toxic to the organisms and to marine life in general in the amounts used.

At operation 210, a primer component is applied to a surface. The primer component does not contain an adhesion-reduction component. The primer component is allowed to partially cure. For example, for the formulation included as Appendix B, the primer component is allowed to partially cure for 1-2 hours, where complete curing would require approximately 6 hours.

At operation 215, an anti-fouling coating including the adhesion reduction component mixed with a topcoat component is applied to the surface over the primer component. The anti-fouling coating may be produced as several components in accordance with one embodiment. For example, a topcoat component, a cure for the topcoat component, and an adhesion-reduction component, may each be produced separately, and then combined prior to application over the primer component.

At operation 220 the primer component and the anti-fouling coating are allowed to fully cure. During the curing process, the primer component and the anti-fouling coating are partially integrated, forming a single coating. The coating then is able to adhere to the surface due to the primer component, while providing substantial adherence-reduction on the surface of the coating (e.g., coated surface).

The following is a list of examples of some components that may be used in conjunction one with another to produce an improved anti-fouling compound including an adhesion-reduction component. Also described is some of the ways in which these components function within an anti-fouling compound.

As mentioned above, for one embodiment of the invention, EPON 828, which is a hexion two-part bisphenol-A-(epichlorhydrin) product is used to provide anti-fouling, compound adhesion, mechanical strength, as well as dielectric and chemical resisting properties.

Heloxy modifier 62 is used to reduce viscosity, it's principal component n-butyl glycidyl ether bonding with the EPON 828. It is used in the amount of 10-15% of the EPON 828.

BYK 535-A is used to help reduce foam to provide reduced pinholes and for leveling. It is used in the amount of 0.1-1% to volume weight.

Disparlon 1983 is a surfactant with low polarity and surface tension that inhibits foaming and improves flow and leveling. It is used in the amount of 0.25-3% to volume weight.

As described above, Cardolite NC 514 is used an epoxy resin which allows flexibility and can be used to reduce brittleness. It is used in the amount of 5.0-10.0% to EPON 828.

As described above, Cardolite 2513-HP is used to form a modifier that improves flow and leveling. It is used in the amount of 10.0-15% to EPON 828.

Cardolite Lite 2002 is a low viscosity, solvent-free epoxy curing agent. It provides reduced dry times and improved intercoat adhesion. It is used in the amount of 10-20% to volume of cross-linking polymers.

Fortega 100 is a low viscosity epoxy toughening agent that remains independent of cross-linking materials. It is used in the amount of 3-8% to volume of cross-linking polymers.

Disparlon F-9050 is a preactivated blend of polyamide and polyolefin used to reduce surface skinning and to form a strong network structure to prevent settling of fillers and pigments. It is used in the amount of 1.5-3.0% to volume weight.

As described above, Busan 11-MI is a modified barium metaborate monohydrate is used for protection against mold, corrosion, tannin staining, microorganisms, and UV radiation. It is used in the amount of approximately 8% to volume of topcoat portion and approximately 10% in the primer portion.

Titanium dioxide is used adjust pigment coloring, resist ultraviolet radiation, and as a strengthener. It is used in the amount of 5-10% of pigment.

Pigment, for example, a powdered pigment, is used in the amount of 5-10% to volume weight.

Degras is an unctuous substance obtained from sheep. It is used as an adherence reduction component. Degras provides a hard waxy finish that reduces adhesion of organisms. It is used in the amount of 10-20% to volume weight. As noted above, for one embodiment, the degras is kept separate from the topcoat mixture until final mixing process.

Di'limonene is a biodegradable solvent derived from orange peels. It is used to dilute the degras to a blendable consistency and to reduce overall viscosity. It is used in the amount of 10-15% to volume of degras.

### General Matters

Embodiments of the invention provide antifouling coatings, compounds and methods. Many variations of anti-fouling formulations are possible and such variations may be preferable in the context of particular applications, available components, cost to manufacture and other considerations.

Embodiments of the invention are not limited to the particular formulations provided as examples. Therefore though embodiments may be described as including various components of various amounts, it should be understood that the components can be substituted with others providing similar described properties and the amounts can be varied depending on a variety of factors including particular applications. For example, for alternative embodiments, a non-toxic organism irritant is used in conjunction with an adherence-reduction component.

Embodiments of the invention have been described as including various operations. Many of the processes are described in their most basic form, but operations can be added to or deleted from any of the processes without departing from the scope of the invention.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. An anti-fouling compound comprising:
a primer component including an epoxy resin and an epoxy toughening agent;
a topcoat component including the epoxy resin and the epoxy toughening agent; and
an adhesion-reduction component, wherein the adhesion-reduction component is mixed with the topcoat component and applied to a partially cured primer component.

2. The anti-fouling compound of claim 1, wherein the adhesion reduction component is an animal-fat based substance.

3. The anti-fouling compound of claim 2, wherein the adhesion-reduction component is degras.

4. The anti-fouling compound of claim 1, wherein the epoxy resin is EPON 828.

5. The anti-fouling compound of claim 4, wherein the epoxy toughening agent is Fortegra 100.

6. A method comprising:
applying a primer component of an anti-fouling compound to a surface;
allowing the primer component to partially cure; and
applying a topcoat component of the anti-fouling compound to the surface over the applied primer component, wherein the topcoat component includes an adhesion-reduction component.

7. The method of claim 6 wherein the primer component includes an epoxy resin and an epoxy toughening agent, the topcoat component includes the epoxy resin and the epoxy toughening agent, and the adhesion reduction component is an animal-fat based substance.

8. The anti-fouling compound of claim 7, wherein the adhesion-reduction component is degras.

9. The anti-fouling compound of claim 7, wherein the epoxy resin is EPON 828.

10. The anti-fouling compound of claim 7, wherein the epoxy toughening agent is Fortegra 100.
